(19) United States
(12) Patent Application Publication
(10) Pub. No.: US 2015/0099062 A1
(43) Pub. Date: Apr. 9, 2015

(54) METHOD FOR MANUFACTURING FILM ELECTRODE

(71) Applicant: National Tsing Hua University, Hsinchu City (TW)

(72) Inventors: Fan-Gang TSENG, Hsinchu City (TW); Yi-Shiuan WU, Hsinchu City (TW); Chia-Lien LU, Hsinchu City (TW); Liang-You LIN, Hsinchu City (TW)

(21) Appl. No.: 14/445,359

(22) Filed: Jul. 29, 2014

(30) Foreign Application Priority Data
Oct. 9, 2013 (TW) 102136466

(51) Int. Cl. H01M 4/88

(52) U.S. Cl. CPC H01M 4/8875; H01M 4/8825; H01M 4/8803; H01M 4/8817; H01M 4/8892; H01M 2250/30
USPC 427/115

(57) ABSTRACT

A method for manufacturing a film electrode is disclosed, which comprises the following steps: (A) providing a polymer substrate, and forming a micro-structure array comprising a plurality of micro holes on the polymer substrate; and (B) depositing sequentially an electron-conductive layer, a catalyst layer, and a proton exchange membrane on the array comprising a plurality of micro holes to form a film electrode; wherein the aspect ratio of the plurality of micro holes is ranging from 2:1 to 5:1.

### CROSS REFERENCE TO RELATED APPLICATION

This application claims the benefits of the Taiwan Patent Application Serial Number 102136466, filed on Oct. 9, 2013, the subject matter of which is incorporated herein by reference.

### BACKGROUND OF THE INVENTION

1. Field of the Invention

The present invention relates to a method for manufacturing a film electrode, more particularly, to a method for manufacturing a film electrode with low cost and high production yield.

2. Description of Related Art

Basic necessities of human life are closely related to energy, and the major source of energy relies on oil. However, oil is not inexhaustible or always available for use. According to the history, three outbreaks of oil crisis caused the inflation of price; therefore, the development for green energy becomes the primary target among nations. It is well known that fuel cells have the features of high energy density, high energy conversion efficiency and environmental friendly (the products are carbon dioxide and water). Moreover, the size of the fuel cells can be minimized to replace batteries, and can be maximized as power plants. The introduced fuel for fuel cells may be hydrogen or methanol, thus the environment would not be polluted while the power is generated. In addition, fuel cells can be slim, light, and can be under long-term operation, which satisfy today's needs for fuel cells. As long as the fuel cell stack is manufactured by a micro-electromechanical system (MEMS) technique, the size of the fuel cells can be miniaturized for the power source application of portable and wearable electronic devices.

In the traditional micro fuel cells, the electrode was prepared by forming a micro-structure array on a silicon chip through a photolithography process, and then sequentially depositing an electron-conductive layer and a catalyst layer thereon. Silicon has an advantage of realizing bulk micro-machining by the MEMS approach. However, the process of the micro-machining for the silicon substrate is complicated and costly, and a deterioration of the packaging yield for the fuel cell stack might be caused due to the brittleness of the silicon material.

Polymer materials characterized by its chemical resistance, heat resistance, easy processing and high flexibility may be applied as a substrate for the fuel cell's electrodes. Therefore, the disadvantages of the silicon-based fuel cell stack packaging, such as high processing cost, complex fabrication process, and the brittleness of the silicon chips can be effectively solved by using polymer materials as the substrate for the fuel cell electrodes. Further, the soft substrate can be formed in different shapes as demanded for the appearance, and the bending of the fuel cells do not affect the performance while discharging.

The development of polymer-based micro fuel cells is to prepare electrodes with fine structures in millimeter size using precision machining techniques. However, the power generated is still not comparable to that generated from the silicon-based micro fuel cells with micro-machined structures (typically a few μm to tens of μm). The limited loading of the catalyst on the catalyst support is incapable of enhancing the current density, thus the application of soft polymer as the electrode substrate for micro fuel cells is challenged.

Therefore, it is desirable to develop a new electrode substrate with low cost and high production yield for micro fuel cells.

### SUMMARY OF THE INVENTION

The object of the present invention is to provide a method for manufacturing a film electrode in order to achieve the high production yield of the film electrode with low cost, and the film electrode has high-aspect-ratio micro structures.

To achieve this object, the method for manufacturing the film electrode of the present invention comprises the steps of: (A) providing a polymer substrate, and forming a micro-structure array comprising a plurality of micro holes on the polymer substrate; and (B) depositing sequentially an electron-conductive layer (also a catalyst support), a catalyst layer, and a proton exchange membrane on the array comprising a plurality of micro holes to form a film electrode; wherein an aspect ratio of the plurality of micro holes is ranging from 2:1 to 5:1.

According to the method of the present invention, the diameter (width) of the plurality of micro holes is not particularly limited, and the micro holes can be designed as needed. The diameter of the plurality of micro holes is preferably ranging from 20 to 100 μm (micrometer, micron), and is more preferably ranging from 20 to 50 μm. The depth of the plurality of micro holes is preferably ranging from 50 to 250 μm, and is more preferably ranging from 50 to 100 μm. Moreover, the thickness of the film electrode is preferably ranging from 50 to 250 μm.

Further, the electron-conductive layer, the catalyst layer, and the proton exchange membrane are not particularly limited, and can be formed using materials known in the art, wherein the electron-conductive layer is preferred to be a graphene layer both as a catalyst support and a current collector. In the current approaches, precious metal gold (Au) is commonly used as the current collector. However, the electron conductivity can easily be deteriorated due to the cracks generated by bending the gold layer. After a long-term operation, in general, the acid corruption of the carbon black, which can be used as the catalyst support inserted the nano gaps between graphene layers, can be solved by sufficiently adding the electron-conductive nanofibers or carbon nanotubes into the gap between graphene layers to form a three-dimensional catalyst support. In addition, the three-dimensional catalyst electrode can be formed selectively by electron-conductive nanofibers and carbon nanotubes with graphene thin-layer and platinum catalyst sequentially deposited on their surfaces. The electro-catalytic electrodes with nano-scale composite structure comprise three-dimensional catalyst supports prepared from the aforementioned two methods having the properties of high specific surface area, high electron conductivity, and high catalytic performance.

According to the method of the present invention, the material for the electrode substrate is not particularly limited, which may be the polymer material used as the electrode substrate in the art, and is characterized by its chemical resistance, heat resistance, easy processing, and high flexibility. For example, engineering plastics, such as polysulfone (PSF) and cyclic olefin polymer (COP), may be used as the electrode substrates, and flexible polymer material, such as polydimethylsiloxane (PDMS), which is capable of reducing the complexity (production yield improvement) and cost of the manufacturing/preparation process, is preferable.

Specifically, step (A) comprises the steps of: (A1) coating a photoresist material on a substrate; (A2) performing a lithography process with a photomask to pattern the substrate to form a master mold having an array comprising a plurality of micro pillars; (A3) forming an anti-adhesion layer on the master mold; (A4) coating the master mold with a solution of polymer; and (A5) curing the solution of polymer and removing the cured polymer film from the master mold to form a soft polymer substrate, wherein an array comprising a plurality of micro holes transferred on the polymer substrate corresponds to the complementary array comprising a plurality of micro pillars of the master mold.

The term “corresponds to the complementary” in the present invention refers that the micro-pillar array of the master mold complements the micro-hole array on the polymer substrate, which is a replication structure from the master mold, if no particular description.

In this case, in step (A1), the substrate may be a silicon substrate, such as silicon wafer, or any substrate in the art; and the photoresist material may be a commonly used photoresist composition for the lithography process, preferably a thick-film photoresist, such as SU-8 negative photoresist. In step (A2), the photomask may be designed according to the master mold, and the processing conditions of the lithography may be easily adjusted by a person skilled in the art. In step (A3), the anti-adhesion layer is not particularly limited as a demolding anti-adhesion layer, and is preferable to be an alkylhalosilane anti-adhesion layer, such as fluorine octyltrichlorosilane silane (FOTS).

A step (A40) may be further comprised prior to step (A4): degassing the air bubbles within the polymer solution. The degassing method is not limited and may be the vacuum degassing method with a vacuum pump. In step (A4), the coating method is not particularly limited, and the master mold is covered by a continuous polymer layer through, for example, spray coating method, roll coating method, spin coating method, slit coating method, compression coating method, curtain coating method, die coating method, wire bar coating method, and blade coating method. A step (A41): removing the excessive polymer from the outer surface of the master mold may be further included after step (A4).

Compared to the micro-structure array manufactured by conventional techniques, the open ratio of the film electrode manufactured by the method of the present invention is estimated to be 300 to 1200 times larger (i.e. open ratio>30%), the specific surface area is 3000 times larger (3 orders of magnitude). Therefore, the method of the present invention is capable of manufacturing tightly packed and high-aspect-ratio (2:1 to 5:1) micro-hole arrays, and the method of the present invention may also reduce the material cost and the complexity of the manufacturing process. Accordingly, the catalyst loading on the catalyst support may be increased due to its high open ratio and high specific surface area, and the power density of the micro fuel cells may be further enhanced.

Recently, soft polymers are used as an electrode material in fuel cells, and the micro-structure array is directly transferred to the soft polymer substrates via casting and rolling techniques. In addition, the original silicon master mold can be used repeatedly, and the manufacturing process of the casting and rolling techniques are simpler, thus reducing the process cost.

In order to increase the configuration flexibility in portable and wearable electronic devices, the soft anode and cathode electrodes can be stacked with a proton exchange membrane to form planar or tubulate membrane electrode assembly (MEA) and become a new green power source with lower cost, lighter weight (40% lighter than conventional silicon-based fuel cells in the same volume), and smaller size for the next generation. Further, according to different ways of supplying fuel and oxidant (air or oxygen), plurality of soft MEAs can be stacked in cascade arrangement to obtain a banded micro fuel cell stack, thus achieving a target of high output voltage and high power density.

### BRIEF DESCRIPTION OF THE DRAWINGS

FIG. 1 is a flow chart of manufacturing process for a film electrode.

FIGS. 2A and 2B are photo images of the substrate of a film electrode of a preferred embodiment.

FIGS. 2C and 2D are SEM images of the substrate of a film electrode of a preferred embodiment.

FIG. 3 is a schematic diagram of a photomask for a master mold.

FIGS. 4A to 4C are SEM images and energy dispersive x-ray spectroscopy spectrum of platinum catalyst supported on carbon fibers without ethanol pretreatment.

FIGS. 5A to 5C are SEM images and energy dispersive x-ray spectroscopy spectrum of platinum catalyst supported on carbon fibers with ethanol pretreatment.

FIGS. 6A to 6C are SEM images and energy dispersive x-ray spectroscopy spectrum of platinum catalyst supported on graphene layer.

FIGS. 7A and 7B are the electrochemical properties of three types of electrodes of the present invention.

FIG. 8 is a schematic diagram of planar membrane electrode assembly.

FIG. 9 is a schematic diagram of tubulate membrane electrode assembly.

FIGS. 10A to 10C are cross-sectional view of a membrane electrode assembly and two partially enlarged views of the same.

FIG. 11 is a schematic diagram of a banded micro fuel cell stack accomplished by cascading the planar membrane electrode assemblies.

FIG. 12 is a schematic diagram of a banded micro fuel cell stack accomplished by cascading the tubulate membrane electrode assemblies.

### DETAILED DESCRIPTION OF THE PREFERRED EMBODIMENT

Preparation of a Film Electrode

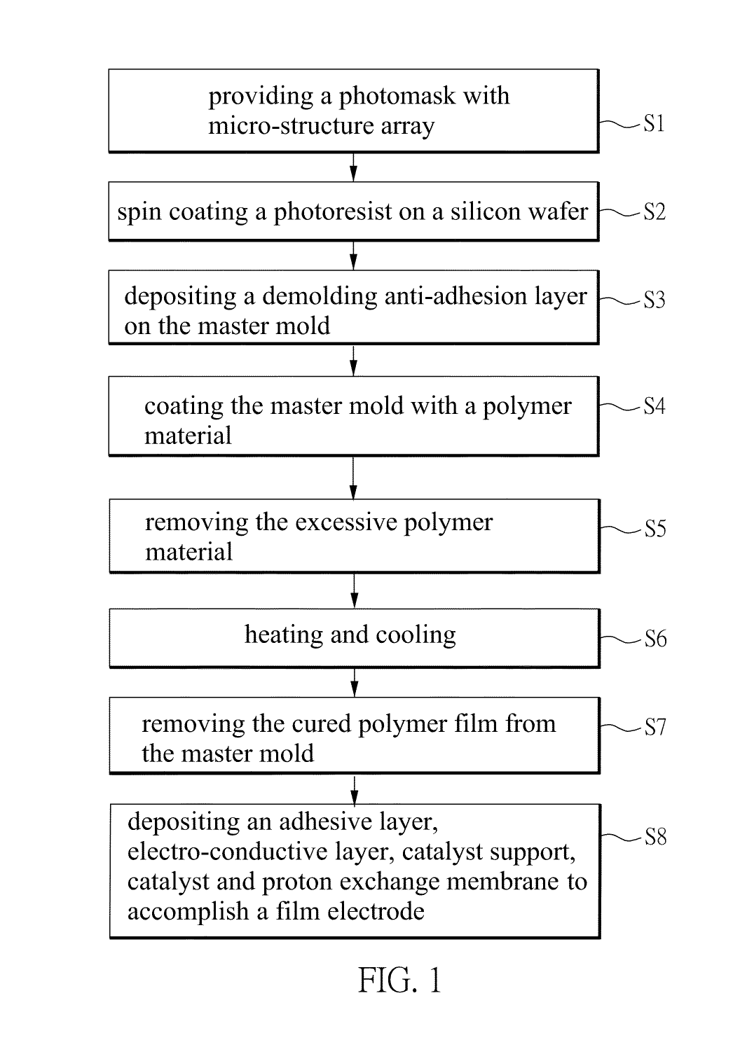

FIG. 1 shows a preferred embodiment of the method for manufacturing a film electrode of the present invention. With reference to FIG. 1, steps S1 to S8 of the manufacturing process will be described in detail as follows. Step S1: providing a photomask with micro-structure array; step S2: spin coating a SU-8 photoresist on a silicon wafer (spin coating speed: 1300˜2000 rpm), performing a lithography process with the photomask (soft baking: heating from 35° C. to 95° C. by 5° C. every step, holding the temperature for 3 minutes, holding the temperature for 30 minutes at 65° C. and 95° C.; post-exposure baking: holding the temperature for 5 minutes at 65° C., and holding the temperature for 1 minute at 95° C.), and removing the unexposed area to form a master mold with plurality of micro pillars, wherein the diameter of the plurality of micro pillars is ranging from 20 to 80 μm, the height is ranging from 50 to 250 μm, and the aspect ratio is approximately 2:1 to 5:1; step S3: depositing a demolding anti-adhesion layer (FOTS) on the master mold; step S4: degassing a prepared solution of PDMS using a vacuum pump for 30 to 40 minutes at room temperature, and coating the master mold with the degassed solution of PDMS to form a continuous polymer film (about 10 μm in thickness) that covers the master mold; step S5: removing the excessive polymer from the outer surface of the master mold; step S6: curing the polymer solution by heating the master mold at 65˜85° C. for 2 hours in an oven; step S7: after cooling, removing the cured polymer film from the master mold to form a soft polymer substrate, wherein an array comprising a plurality of micro holes transferred on the polymer substrate corresponds to the complementary array comprising the plurality of micro pillars of the master mold; and step S8: depositing sequentially an adhesive layer, electron-conductive layer, catalyst support, catalyst and proton exchange membrane that conducting ions to accomplish a film electrode.

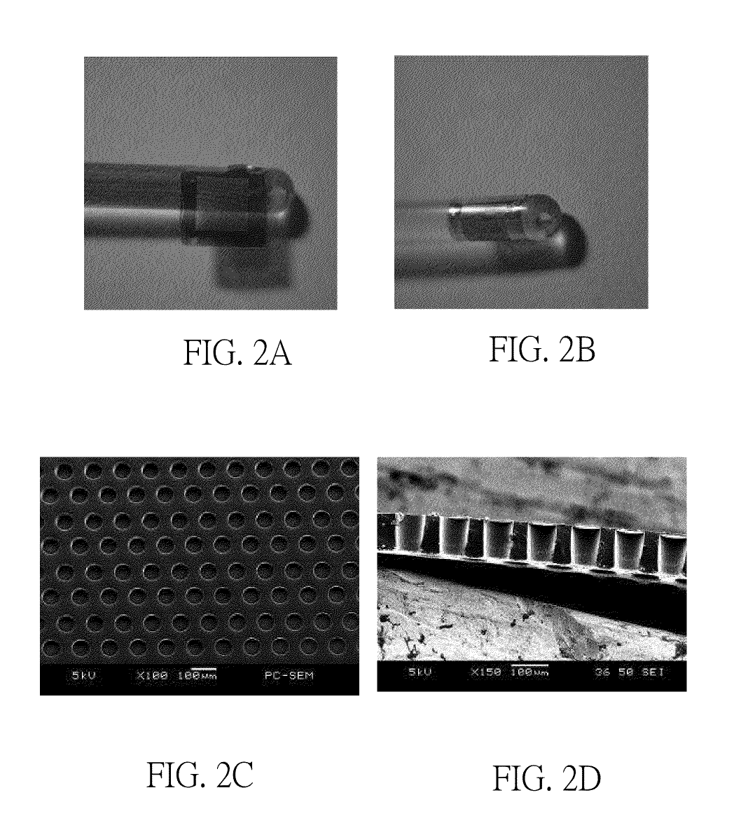

Referring to FIGS. 2A and 2B, which show the photo images of the accomplished substrate of a film electrode, wherein FIG. 2A is the image that the substrate of a film electrode placed on a glass rod, and FIG. 2B is the image that the substrate of a film electrode curled along the glass rod (for clear illustration, a thin gold layer is deposited on the transparent substrate of a film electrode). FIG. 2C is a top-view SEM image of the substrate of a film electrode, and FIG. 2D is a cross-sectional SEM image of the substrate of a film electrode. Accordingly, the obtained film electrode with dimensions of 1 cm (L)×1 cm (W)×100 μm (T) is a flexible soft polymer substrate which is characterized by high open ratio and high specific surface area. And the array of micro holes, which has a depth of about 100 μm, and a diameter of about 80 μm, extends completely through the thickness of the film electrode substrate.

The adhesive layer may be titanium (Ti), chromium (Cr), or aluminum (Al), the electron-conductive layer may be a graphene film with high conductivity and high strength, which comprises a nano spacer made of electron-conductive nanofibers or carbon nanotubes with diameter of tens of nanometers. The three-dimensional composite structure may be a catalyst support with high specific surface area for supporting electro-catalytic metal catalysts, such as platinum or platinum alloys. In addition, the electron-conductive nanofibers or carbon nanotubes may be selectively forming a network structure with graphene thin-layer incorporated thereon for supporting platinum catalyst. The aforementioned two methods are provided to manufacture a catalyst electrode having three-dimensional nano structure and characterized by high specific surface area, high conductivity, and high catalytic performance. Finally, proton exchange membrane is implanted adjacent to the catalyst to effectively transport the protons produced from the electrochemical reaction.

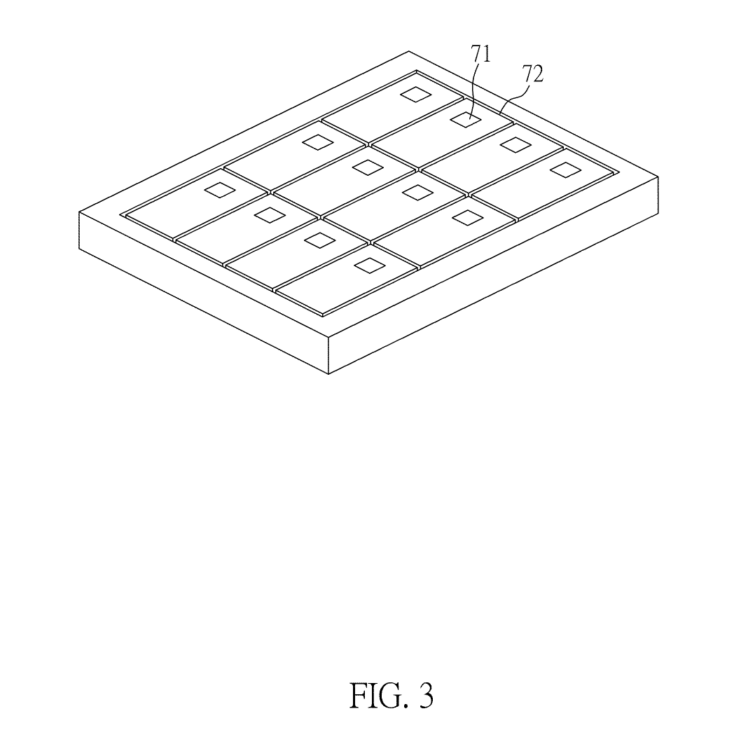

In the aforementioned step S1, the photomask is shown in FIG. 3. The photomask comprises micro-array area 71 and slideway area 72, therefore, the master mold formed by using this mask further comprises a plurality of slideway walls in addition to a plurality of micro pillars, and the slideway walls with a certain width have the same height with the micro pillars. In the aforementioned step S5, the excessive polymer material is removed by scraping along the slideway surface without damaging the micro-pillar array. In this embodiment, the area of the electrode substrate sample is 1 cm×1 cm, 20 densely-arranged samples may be prepared simultaneously on one 4-inch silicon wafer.

Accordingly, the method for manufacturing a film electrode provided by the present invention can effectively solve the following two major problems of the silicon-based electrodes in conventional fuel cells: brittleness of the silicon substrate while packaging the membrane electrode assembly, and low production yield. Further, it should be noted that the silicon master mold for the replica molding technique of soft substrates can be used repeatedly, thus the cost for manufacturing silicon substrates can be reduced (such as materials, manufacturing process and time, etc.). Soft polymers can be effectively applied as electrode substrates due to its cheap, easy processing, and flexible properties.

Catalyst Electrode Test

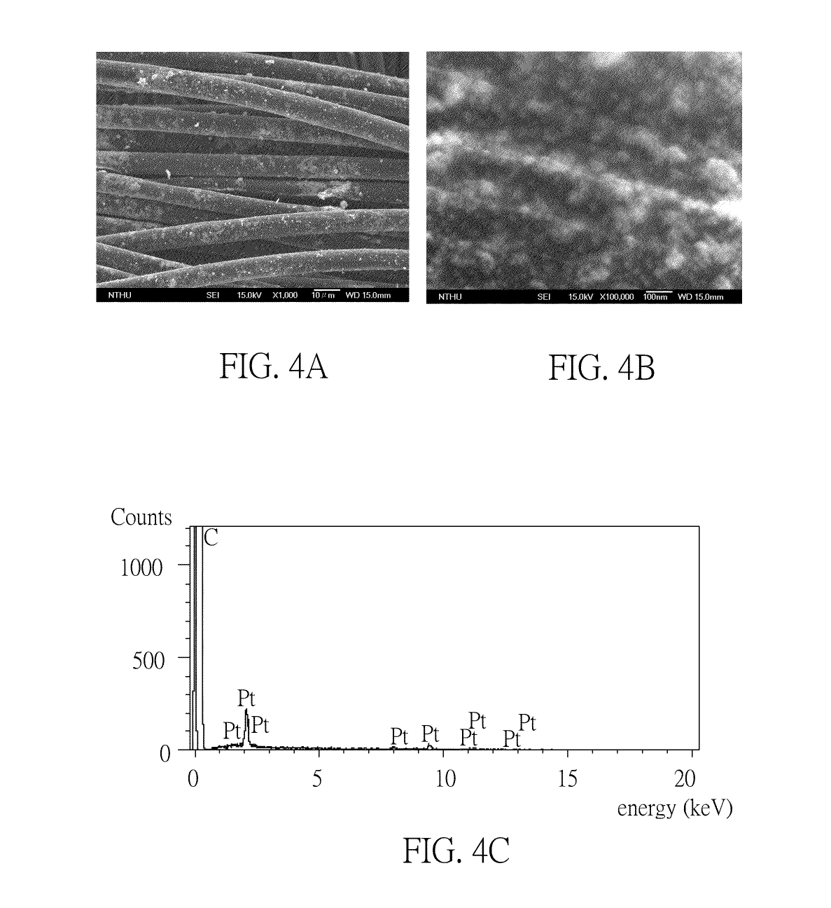

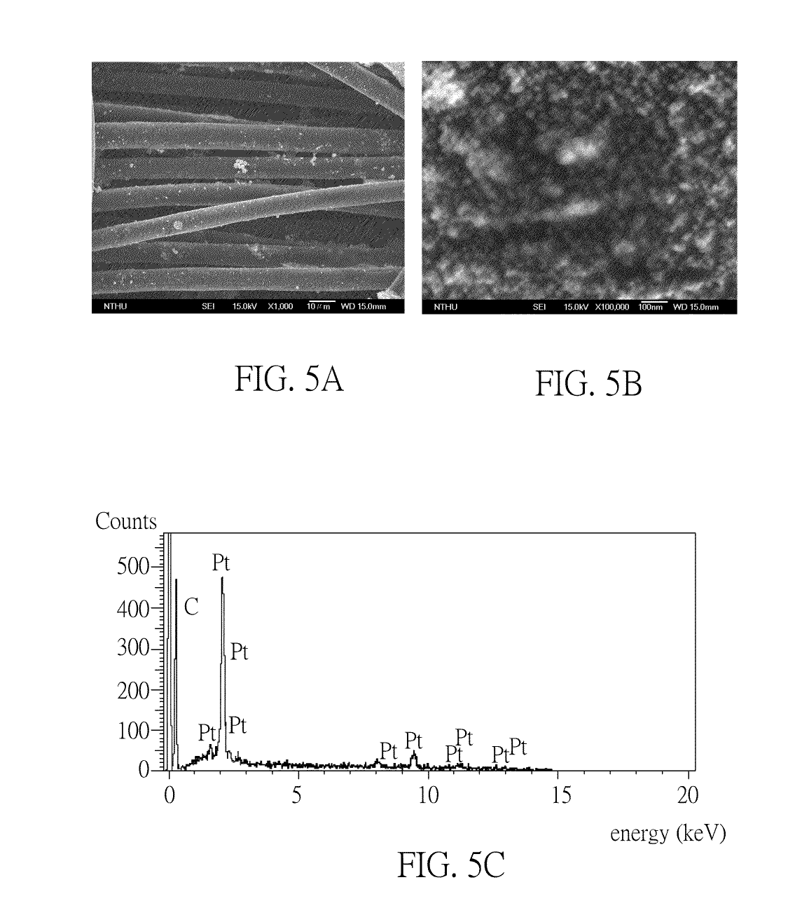

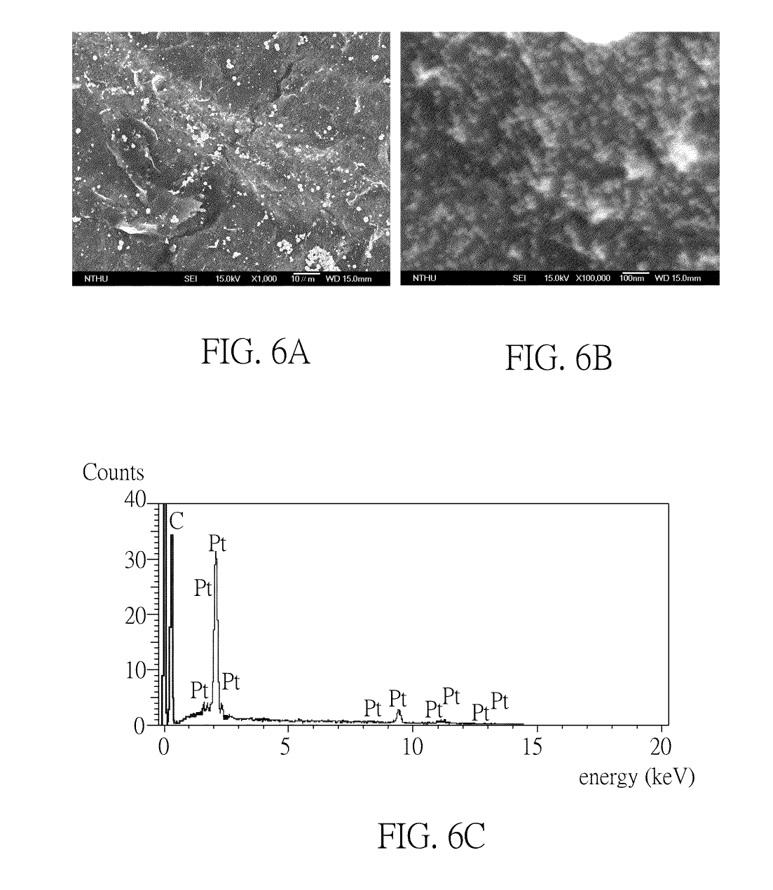

Platinum (Pt) nanoparticles are deposited respectively on different catalyst supports to form catalyst electrodes, in which FIGS. 4A˜4C; FIGS. 5A˜5C; and FIGS. 6A˜6C respectively show the scanning electron microscopy (SEM) images and energy dispersive x-ray spectroscopy (EDX, or EDS) spectrum of carbon fiber (CF) supported platinum catalyst without ethanol pretreatment; carbon fiber supported platinum catalyst with ethanol pretreatment; and graphene layer (GL) supported platinum catalyst, wherein FIGS. 4A, 5A, and 6A show the low-magnification SEM images; FIGS. 4B, 5B, and 6B show the high-magnification SEM images; and FIGS. 4C, 5C, and 6C show the spectrum results of energy dispersive x-ray spectroscopy.

Referring to FIG. 4A and FIG. 5A, in the case of platinum catalyst supported on the carbon fibers pretreated with ethanol, the aggregation of platinum catalyst particles supported on the carbon fibers is less significant; and refer to FIG. 4B and FIG. 5B, the platinum catalyst supported on the carbon fibers pretreated with ethanol distribute uniformly with smaller size. Also refer to FIG. 4C and FIG. 5C, the atom ratios of Pt/C analyzed by the EDX semi-quantitative analyses are 1/99% and 3/97%, respectively. Accordingly, the platinum loading on the carbon fibers with ethanol pretreatment is three times larger than that on the carbon fibers without ethanol pretreatment. Referring now to FIGS. 6A˜6C, in the case of platinum catalyst supported on the graphene layer, the platinum particles distribute uniformly with smaller size and higher density. The EDX semi-quantitative analysis shows that the atom ratio of Pt/C is 4/96%, therefore, the platinum catalyst supported on the graphene layer distribute more uniformly, and the catalyst loading of the graphene layer is more than those mentioned above. However, for larger loading of platinum catalyst, aggregation of platinum particles would occur easily if the catalyst is not well distributed by adjusting the manufacturing process to provide the support with sufficiently high specific surface area, causing the platinum particles aggregate on the surface of the graphene layer, which is shown in FIG. 6A.

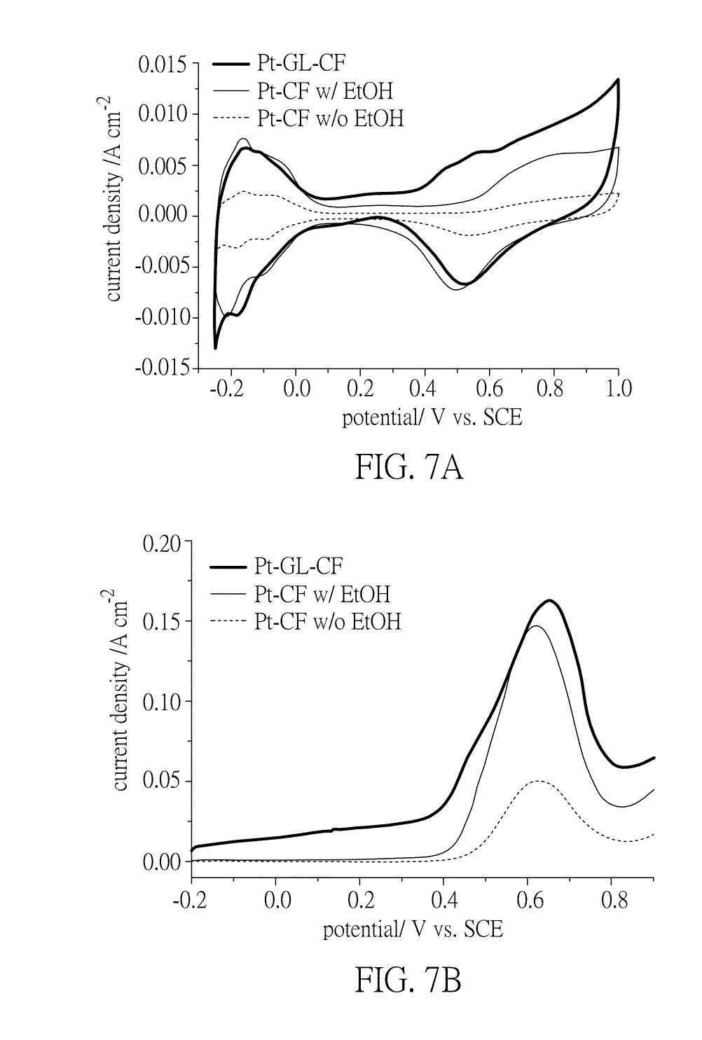

FIGS. 7A, 7B show the analysis results of electrochemical performance of the catalyst electrodes mentioned above, which are Pt-CF w/o EtOH, Pt-CF w/EtOH, and Pt-GL-CF respectively (EtOH: ethanol). FIG. 7A shows the cyclic voltammetry curves of the three catalyst electrodes in 0.5 M sulfuric acid solution, that is, the amounts of charge transfer (Q_{H}) generated by the absorption/desorption of hydrogen ion (H⁺) on the surfaces of the platinum catalyst are respectively 6.6, 17.1, and 22.6 mC cm⁻², which may represent the surface area of platinum that participate in the electrochemical reaction. And the results show that the platinum catalyst supported on the graphene layer (Pt-GL-CF) has the largest reaction surface area, which is 3.4 times larger than that on the carbon fibers without ethanol pretreatment (Pt-CF w/o EtOH). In addition, FIG. 7B shows the CV curves of the three catalyst electrodes in 1 M methanol and 0.5 M sulfuric acid solutions, that is, the performance of the methanol oxidation electro-catalyzed by the platinum catalyst electrodes. The peak current densities (I_{P}) of the three catalyst electrodes are respectively 51, 147, 163 mA cm⁻². The Pt-GL-CF catalyst electrode shows the best electrochemical performance, which is 3.2 times larger than the Pt-CF w/o EtOH catalyst electrode. The ratio of the methanol electro-catalytic reaction for the three catalyst electrodes shown in FIG. 7B is consistent with the ratio of the platinum reaction surface area of the three catalyst electrodes shown in FIG. 7A. The Pt-GL-CF catalyst electrode and Pt-CF w/o EtOH catalyst electrode, for example, the ratios of Iₚ and Q_{H} are 3.2 and 3.4.

Membrane Electrode Assembly of Micro Fuel Cell

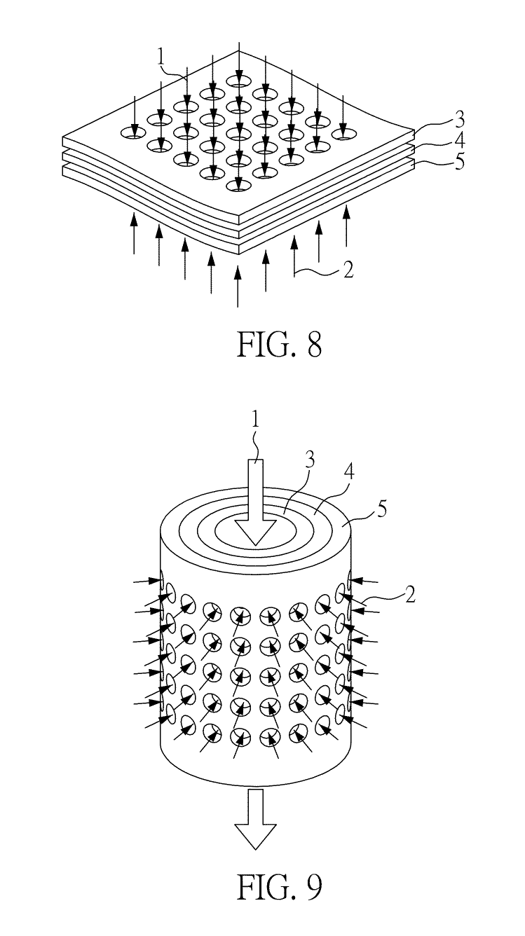

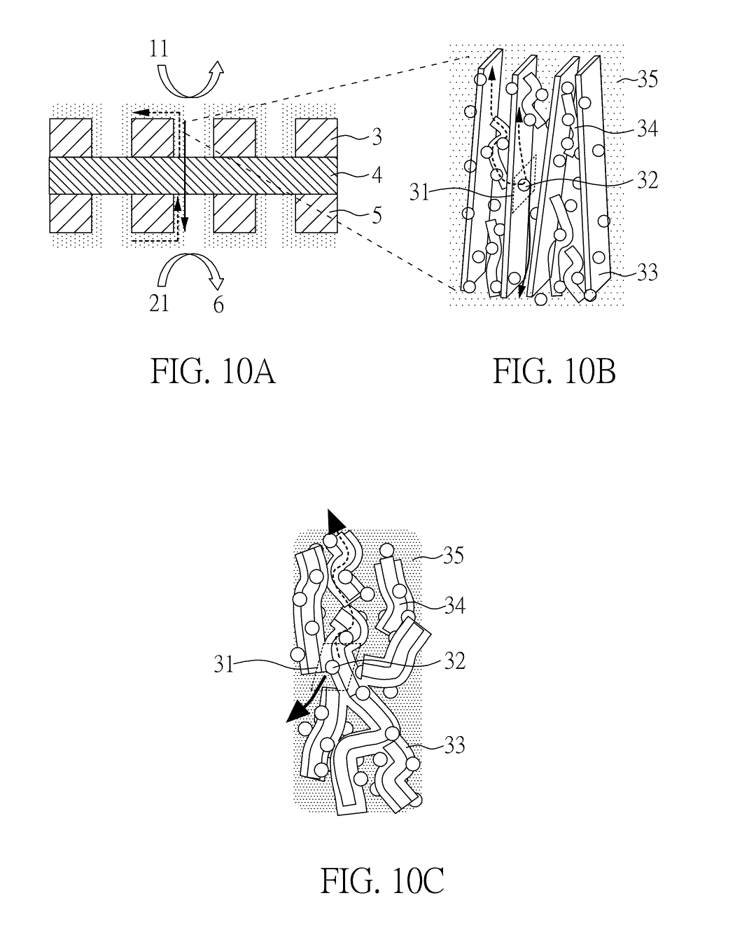

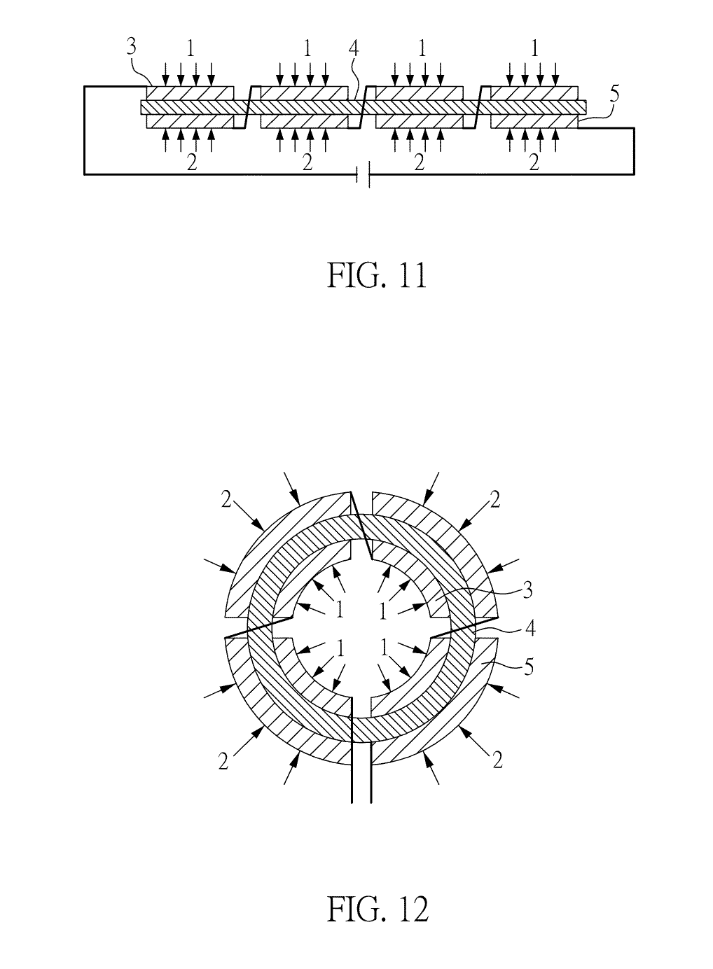

Different types of the membrane electrode assembly (MEA) of the single fuel cell are integrated by a conventional hot pressing method to combine an anode, a cathode, and a proton exchange membrane, as shown in FIG. 8 and FIG. 9. The hot-pressing temperature is controlled in a range of the glass transition temperature (T_{g}) of the materials used as the membrane electrode assembly, and the hot-pressing pressure is controlled in a range of MPa. The proton exchange membrane may be a solid thin film that transports protons, and the thickness is between 50˜200 μm. The micro fuel cell comprises fuel feeding inlet 1, oxidant feeding inlet 2, and membrane electrode assembly comprising anode 3, proton exchange membrane 4, and cathode 5. FIG. 8 shows a planar membrane electrode assembly, and FIG. 9 shows a tubulate membrane electrode assembly. FIGS. 10A to 10C represent the cross-sectional view of a membrane electrode assembly and two partially enlarged views of the same, wherein the enlarged views in FIG. 10B shows the three-phase reaction zone in the micro hole at anode 31, comprising catalyst nanoparticles 32 (platinum), plurality of graphene thin-layers 33 with nano-scale thickness, electro-conductive nanofibers or carbon nanotubes 34 with diameter of tens of nanometers, and ion-conductive proton exchange membrane 35 with thickness of few nanometers, which transports ions (membrane cured and formed after coating the liquid Nafion® ionomer). In addition, the difference between the three-phase reaction zones shown in FIGS. 10C and 10B is that using electron-conductive nanofibers or carbon nanotubes 34 to form a network structure with incorporation of graphene thin-layers 33 with nano-scale thickness, and catalyst nanoparticles 32 (platinum) deposited on the formed network. The solid-line and dotted-line arrows shown in FIGS. 10B and 10C represent the transport paths of hydrogen ion (H⁺) and electron (e⁻), respectively. The electrochemical reaction occurs in the three-phase reaction zone at anode is as follows: an electrochemical reaction occurs when the fuel 11 introduces from the fuel feeding inlet 1 and contacts the surface of the catalyst nanoparticles 32, and the electron generated by the electrochemical reaction can be transported along three-dimensional directions (XYZ) configured by graphene thin-layers 33 and electron-conductive nanofibers or carbon nanotubes 34. And the hydrogen ion can be transported to cathode 5 from the catalyst nanoparticles 32 and their adjacent proton exchange membrane 35. Further, the oxidant 21 (air or oxygen) introduces from the oxidant feeding inlet 2 at cathode 5 reacts with the electrons and the hydrogen ions transported from the anode 3 to produce water 6.

Further, according to the design types of the membrane electrode assembly (planar or tubulate) and the supply methods of fuel and oxidant, plurality of membrane electrode assemblies may be cascaded a banded micro fuel cell stack, as shown in FIGS. 11 and 12, depicting the micro fuel cell stacks having four cascaded membrane electrode assemblies.

The present invention disclosed a flexible soft polymer-based film electrode with a micro-structure array, and the manufacturing method thereof is able to resolve the brittleness problems of conventional silicon-based electrode during the packaging process of the membrane electrode assembly. The improvement of micro-scale design and the repeatable replica molding technique may significantly enhance the open ratio and specific surface area of the conventional polymer-based electrodes, and higher current density can be achieved via the high loading density and high dispersion of the electro-catalytic catalyst supported on the three-dimensional nano supports. Meanwhile, the cascaded membrane electrode assemblies can improve the power output, and thus high power density may be reached with an estimation of hundreds of mW cm⁻² to few W cm⁻². Accordingly, the polymer-based micro fuel cell stacks with low current density and low power density (tens to hundreds of μW cm⁻²) can be further improved. In the near future, the soft polymer-based fuel cells may be applied as thin flexible film panels or be embedded into all shapes of portable and wearable electronic devices as micro power supplies.

Although the present invention has been explained in relation to its preferred embodiment, it is to be understood that many other possible modifications and variations can be made without departing from the spirit and scope of the invention as hereinafter claimed.

What is claimed is:

1. A method for manufacturing a film electrode, comprising the steps of:
(A) providing a polymer substrate, and forming a micro-structure array comprising a plurality of micro holes on the polymer substrate; and
(B) depositing sequentially an electron-conductive layer, a catalyst layer, and a proton exchange membrane on the array comprising a plurality of micro holes to form a film electrode;
wherein an aspect ratio of the plurality of micro holes is ranging from 2:1 to 5:1.

2. The method as claimed in claim 1, wherein a thickness of the film electrode is ranging from 50 to 250 μm.

3. The method as claimed in claim 1, wherein the polymer substrate is made of polydimethylsiloxane (PDMS).

4. The method as claimed in claim 1, wherein the electron-conductive layer is a graphene layer.

5. The method as claimed in claim 1, wherein the electron-conductive layer is a catalyst support, and the catalyst support comprises a nano spacer, wherein the nano spacer is made of electron-conductive nanofibers or carbon nanotubes.

6. The method as claimed in claim 1, wherein the electron-conductive layer is a catalyst support, the catalyst support is composed of electron-conductive nanofibers or carbon nanotubes, and graphene layers are disposed on the electron-conductive nanofibers or carbon nanotubes.

7. The method as claimed in claim 1, wherein step (A) comprises the steps of:
(A1) coating a photoresist material on a substrate;
(A2) performing a lithography process with a photomask to pattern the substrate to form a master mold having an array comprising a plurality of micro pillars;
(A3) forming an anti-adhesion layer on the master mold;
(A4) coating the master mold with a liquid polymer; and
(A5) curing the polymer and removing the master mold to form a cured polymer substrate, wherein an array comprising a plurality of micro holes transferred on the polymer substrate corresponds to the complementary array comprising a plurality of micro pillars of the master mold.

8. The method as claimed in claim 7, wherein the substrate is a silicon wafer.

9. The method as claimed in claim 7, wherein the photoresist material is SU-8 negative photoresist.

10. The method as claimed in claim 7, wherein the demolding anti-adhesion layer is an alkylhalosilane layer.
